(19) United States
(12) Patent Application Publication
(10) Pub. No.: US 2026/0360104 A1
(43) Pub. Date: Nov. 12, 2026

(54) UNDERWATER ACOUSTIC OBJECT RECOGNITION METHOD BASED ON ADJUSTABLE EFFECTIVE RECEPTIVE FIELD (ERF)

(71) Applicant: ZHEJIANG UNIVERSITY, Zhoushan (CN)

(72) Inventors: Fengzhong QU, Zhoushan (CN); Haodi ZHU, Zhoushan (CN); Shaojian YANG, Zhoushan (CN); Yan WEI, Zhoushan (CN); Jiang ZHU, Zhoushan (CN); Xingbin TU, Zhoushan (CN)

(73) Assignee: ZHEJIANG UNIVERSITY, Zhoushan (CN)

(21) Appl. No.: 19/342,741

(22) Filed: Sep. 29, 2025

Related U.S. Application Data
(63) Continuation-in-part of application No. PCT/CN2024/091194, filed on May 6, 2025.

(51) Int. Cl. G06V 10/44; G06N 3/0464; G06N 3/084; G06N 3/0985; G06V 10/32; G06V 10/74; G06V 10/77; G06V 20/05

(52) U.S. Cl. CPC G06V 10/454; G06N 3/0464; G06N 3/084; G06N 3/0985; G06V 10/32; G06V 10/761; G06V 10/7715; G06V 20/05; G06V 2201/07

(57) ABSTRACT

An underwater acoustic object recognition method based on an adjustable effective receptive field (ERF) is provided. The underwater acoustic object recognition method proposes an adjustable effective receptive field U-shape network (AEU-Net) model with multiple resolution branches, where the resolution branches each include independent convolutional kernels that adaptively adjust respective sizes while matching with a resolution during training; and the AEU-Net model includes an ERF-Server for adjusting an ERF during forward propagation, that is, to increase or reduce the ERF of a feature map in any specified module. The underwater acoustic object recognition method can capture the acoustic physical information of underwater acoustic object samples across multiple interactive dimensions and perform feature fusion of multi-scale ERF information to adapt to sonar image objects of different sizes. In this way, the underwater acoustic object recognition method improves the accuracy and speed of underwater acoustic object recognition.

### CROSS REFERENCE TO THE RELATED APPLICATIONS

This application is the continuation-in-part application of International Application No. PCT/CN2024/091194, filed on May 6, 2024, the entire contents of which are incorporated herein by reference.

### TECHNICAL FIELD

The present disclosure relates to the field of marine underwater object recognition, and in particular to an underwater acoustic object recognition method based on an adjustable effective receptive field (ERF).

### BACKGROUND

Underwater acoustic object recognition is essentially an image processing problem, which typically employs a semantic segmentation model to predict each pixel of an image based on feature information extracted from the image. Currently, semantic segmentation tasks on mainstream underwater acoustic datasets are primarily affected by factors such as complex marine environments (e.g., object occlusion, object posture changes, multiple objects, and uneven illumination) and strong noise interference. Underwater acoustic object recognition dataset samples include a large amount of acoustic physical information and are highly sensitive to the model's global perceptual capability in space. Currently, compared to time-frequency-based methods, deep learning (DL)-based recognition methods show significant advantages in performance metrics and real-time capability, and have become the mainstream methods in the field.

The concept of effective receptive field (ERF) is proposed relative to the theoretical receptive field. ERF only occupies a small portion of theoretical receptive field. As the number of layers increases, the proportion of the model's ERF within the theoretical receptive field diminishes, and the rate of this contraction also decelerates. Therefore, relying solely on stacking layers provides little improvement to the model's ERF when the number of layers is large. Currently, there is a lack of DL-based models, particularly a lack of research on ERF-based vision models, in related fields.

Most existing convolutional vision models are based on small-kernel (3*3) residual blocks proposed by the residual neural network (ResNet), which means that even a large number of layers cannot achieve a large ERF. In underwater acoustic object recognition tasks, since frequency domain information is uniformly distributed throughout the entire sample, models used on general datasets cannot extract sufficient and global information. Even though small-kernel networks, such as the high-resolution network (HRNet), can achieve better spatial sensitivity through multi-path interaction and maintaining high-resolution representations globally, they cannot perform well on underwater acoustic object datasets due to insufficient ERF resources. Existing model research targets multi-path resolution representations, different-sized convolutional kernels, or directly targets ERF. The main research approach has been to conduct respective experiments on representations (feature semantic information) with different depths or sizes or convolutional kernels (feature semantic extraction means), often achieving good results. For example, HRNet uses 3*3 residual blocks, while re-parameterized large kernel network (RepLKNet) does not consider multi-path resolution fusion. However, exploration into multi-scale fusion of both aspects and into their matching and adaptive relationship is relatively rare. On the other hand, the effectiveness of ERF has been extensively proven in vision models such as vision transformer and swin transformer (ViTs). These vision models have strong performance in numerous downstream computer vision tasks, which is partially attributed to the increase in the ERF brought by the large parameter count inherent in the model design.

### SUMMARY

In view of the deficiencies of the prior art, the present disclosure proposes an underwater acoustic object recognition method based on an adjustable ERF. The present disclosure directly implements the design based on the kernel size positively correlated with the ERF to specifically extract multi-scale ERF information for fusion and interaction.

Specifically, the present disclosure adopts the following specific technical solution:

An underwater acoustic object recognition method based on an adjustable ERF includes following steps:
S1: constructing a pixel-wise-labeled underwater sonar segmentation image dataset;
S2: constructing and training an adjustable effective receptive field U-shape network (AEU-Net) model based on a U-shape network (U-Net), specifically including following sub-steps:
S2.1: embedding an information interaction module of a high-resolution network (HRNet) into each single-resolution module of the U-Net, and expanding each module into first and second resolution branches; downsampling an original image after the original image passes through a preprocessing convolutional layer; inputting, in a downsampling stage, an output of the first branch in a previous module to the first branch of a corresponding module in an upsampling stage via a skip connection, where the corresponding module is determined based on feature maps of an identical resolution; splitting an output of the second branch in the previous module into two paths: one convolved through a residual block with a stride of 1 and serving as an input for the first branch in a next module and the other downsampled through a residual block with a stride of 2 and serving as an input for the second branch in the next module; upsampling and inputting, during an upsampling process, an output of the first branch in the previous module to the first branch in the next module; convolving the output of the first branch in the previous module through a residual block with a stride of 1 to form an input for the second branch in the next module; and concatenating the outputs of the second branches of each module in the upsampling stage along a channel dimension, and outputting a classification label after sequentially performing one-dimensional (1D) convolution and processing through a fully connected layer;
S2.2: reconstructing convolutional kernels in each branch by depth-wise convolution (DW conv), where the DW conv is implemented through an adaptively-sized convolutional kernel with a size matching with the resolution of the feature map of each branch;
S2.3: constructing an ERF-Server network branch to implement the skip connection, and completing the construction of the AEU-Net model, where the ERF-Server network branch includes two operations: U-Serve and D-Serve: acquiring, for a feature map representation output by each module during downsampling, new semantic information with an increased ERF after processing by a large-kernel convolution block of U-Serve; acquiring, for the feature map representation output by each module during downsampling, new semantic information with a reduced ERF after processing by a fixed-size 3*3 residual convolution block of D-Serve; and concatenating an upsampled output of the first branch in the previous module of the corresponding module in the upsampling stage with an output of U-Serve and an output of D-Serve into the corresponding module in the upsampling stage according to a channel allocation coefficient; and
S2.4: inputting the underwater sonar segmentation image dataset into the AEU-Net for training, and acquiring a trained AEU-Net model, where during training, the size of the adaptively-sized convolutional kernel is adjustable within a preset kernel size interval for the feature map of a current module; and a training goal is to minimize a loss function of the adaptively-sized convolutional kernel; and
S3: inputting an underwater sonar segmentation image to be tested into the trained AEU-Net model, and acquiring a recognition result.

Furthermore, in the step S2.2, in DW conv, one convolutional kernel is responsible for one channel, one channel is convolved by only one convolutional kernel, and a number of channels in the feature map after convolution equals a number of input channels; and the adaptively-sized convolutional kernel controls the size through the loss function.

Furthermore, update logic for the loss function of the adaptively-sized convolutional kernel during training is as follows: the loss function of the adaptively-sized convolutional kernel guides the adaptive convolutional kernel to select and update the size based on a difference between a predicted pixel and a pixel in a ground truth label for samples of different classes during each training;
based on the update logic for the loss function of the adaptively-sized convolutional kernel during training, objects to be recognized in the underwater sonar segmentation image dataset are divided into two classes: a first object and a second object; if the corresponding loss function increases when a predicted pixel of the first object presents mispositioning or insufficient filling compared to the ground truth label, the loss function is reduced by increasing the size of the adaptive convolutional kernel; if the corresponding loss function increases when a predicted pixel of the second object presents missed detection or false determination compared to the ground truth label, the loss function is reduced by decreasing the size of the adaptive convolutional kernel; and the loss function is expressed as follows:

loss~\sqrt{kₚ*prediction deviation of second object}+\sqrt{prediction deviation of first object−kₚ}
where, kₚ denotes a dimensionally normalized value for a prediction deviation between the size of the adaptive convolutional kernel in the current module and the first object as well as the second object.

Furthermore, a small-object prediction deviation is expressed by a Hausdorff distance, specifically as follows:

Hausdorff(A,B)=max{h(A,B),h(B,A)}

h(A,B)=max_{a∈A} min_{b∈B}∥a−b∥

h(B,A)=max_{b∈A} min_{a∈B}∥b−a∥
a large-object prediction deviation is expressed by a Dice coefficient, specifically as

$$Dice = \frac{2 \times \vert A ⋂ B \vert}{\vert A \vert + \vert B \vert}$$

where, A={a¹, a², . . . , a^{p}}, B={b¹, b², . . . , b^{p}}; A is a predicted pixel set; B is a ground truth label pixel set; and ∥a−b∥ denotes a Euclidean distance between two pixels.

Furthermore, the size of the adaptive convolutional kernel is adjustable within the preset kernel size interval for the feature map of the current module, and kernel size intervals corresponding to feature maps of different resolutions do not overlap; and the kernel size interval is determined by a size function expressed as follows:

$${k}_{m} = f ( r )$$

$$f ( r ) = \frac{2 ln ( {r}^{3} + 1 )}{1 + {e}^{- r}}$$

where, kₘ denotes a median of the kernel size interval for the adaptive convolutional kernel; f(r) denotes the size function; and r denotes a size of the feature map representation of the current module.

Furthermore, upsampling is implemented through bilinear interpolation.

Furthermore, in the step S2.3, the channel allocation is implemented through the channel allocation coefficient denoted as Cₖ; the channel allocation coefficient Cₖ is a preset hyperparameter, a 1*3 vector; each component is between 0 and 1 and sums to 1, representing proportions of three feature maps from the output of D-Serve, the output of U-Serve, and the upsampled output of the first branch in the previous module of the corresponding module in the upsampling stage; and rounding is applied to a number of channels during allocation.

Furthermore, the step S2.4 includes: acquiring an ERF distribution of the feature maps of each module in the entire AEU-Net model; and calculating an actual ERF based on the size of the adaptively-sized convolutional kernel in each branch and a number of convolutional layers the branch passes through as follows:

$$\sqrt{Var [ Sn ]} = \sqrt{n ( {\sum }_{i = 0}^{k - 1} {\sum }_{j = 0}^{k - 1} ( {i}^{2} + {j}^{2} ) \cdot \frac{1}{{k}^{2}} - {( {\sum }_{i = 0}^{k - 1} {\sum }_{j = 0}^{k - 1} i \cdot \frac{1}{k} )}^{2} - {( {\sum }_{i = 0}^{k - 1} {\sum }_{j = 0}^{k - 1} j \cdot \frac{1}{k} )}^{2} )}$$

that is,

ERF~k\sqrt{n}
where, \sqrt{Var[Sₙ]} denotes a standard deviation of a pixel value Sₙ output by an n-th convolutional layer; (i, j) denotes an index of an element in an i-th row and a j-th column of the k×k adaptively-sized convolutional kernel; k denotes the size of the adaptively-sized convolutional kernel for convolving the feature map of each module for an underwater acoustic object signal; and n denotes a cumulative number of stacked layers from the input of the original image to a current convolutional layer.

An electronic device includes a memory and at least one processor, where the memory is configured to store an executable code; and the executable code is executed by the at least one processor to implement the underwater acoustic object recognition method based on an adjustable ERF.

A computer-readable storage medium is configured to store a program, where the program is executed by a processor to implement the underwater acoustic object recognition method based on an adjustable ERF.

The present disclosure has following beneficial effects.
(1) The AEU-Net model constructed by the present disclosure is based on the general models U-Net and HRNet in the field of computer vision, and is specialized for underwater acoustic datasets through an independently designed network branch called ERF-Server. It can transform the originally fixed ERF attribute dependent on the network structure into something adjustable and trainable, further utilizing this characteristic to allow each module of the model to better extract physical features from the underwater acoustic dataset, and fuse semantic information from ERFs at various scales from large to small. In this way, the present disclosures improve the recognition accuracy and adaptability for sonar objects of different sizes.
(2) The structure proposed by the present disclosure matches convolutional kernel size with feature map resolution. It can use large kernels to extract richer global information and object shape information from high-resolution representations, and use small kernels to extract finer local texture information from low-resolution representations, unlike previous networks that consistently used overly large convolutional kernel groups or overly small 3×3 residual blocks. Therefore, the present disclosure can significantly reduce the parameter count and increase training speed compared to the large kernel groups commonly used on standard datasets, while improving performance, enabling the model to be applied in scenarios with high real-time requirements such as underwater environments.
(3) The AEU-Net model proposed by the present disclosure uses a reconstructed adaptive multi-scale information interaction module. It uses matching convolutional kernels at each resolution module to efficiently extract different information at the current scale, and supplements it with the feature map semantic information acquired from the two semantic branches, U-Serve and D-Serve, adjusted by ERF-Server in the preceding downsampling module. This allows for the fusion of current size/resolution-matched semantic information, global large ERF information, and global small receptive field information. Compared to a global large kernel design, the present disclosure can achieve information fusion from both scale resources of semantic resources and ERF with a relatively small parameter count. Therefore, the present disclosure enhances the feature extraction capability for underwater acoustic object images with physical information covering the entire sample image and requiring high global perception capability.

### BRIEF DESCRIPTION OF THE DRAWINGS

FIG. 1 is a flowchart of an underwater acoustic object recognition method based on an adjustable ERF in an embodiment of the present disclosure;

FIG. 2 is a schematic diagram of a backbone network of AEU-Net constructed in an embodiment of the present disclosure;

FIG. 3 is a schematic diagram of matching between a median of a variable kernel size and a representation size of a feature map in an embodiment of the present disclosure;

FIG. 4 is a comparative example of effects of ERF-Server of the present disclosure and the prior art;

FIG. 5 is a schematic diagram of fusion details of three-dimensional information in each resolution module during an upsampling process in an embodiment of the present disclosure;

FIG. 6 is a comparative diagram of losses under different ERF adjustments in an embodiment of the present disclosure;

FIGS. 7A-7D are diagrams of imaging effects of different samples in forward-looking sonar and processing effects on different models in an embodiment of the present disclosure, where FIG. 7A is an effect diagram of a first sample, FIG. 7B is an effect diagram of a second sample, FIG. 7C is an effect diagram of a third sample, and FIG. 7D is an effect diagram of a fourth sample; and

FIG. 8 is a schematic diagram of an electronic device for implementing the underwater acoustic object recognition method based on an adjustable ERF in an embodiment of the present disclosure.

### DETAILED DESCRIPTION OF THE EMBODIMENTS

The present disclosure is described in detail below with reference to the drawings and preferred embodiments to make its objective and effects clearer. The following further elaborates on the present disclosure in conjunction with the drawings and embodiments. It should be understood that the specific embodiments described herein are only intended to explain the present disclosure and are not intended to limit the present disclosure.

An underwater acoustic object recognition method based on an adjustable ERF includes following steps.

S1: An underwater sonar segmentation image dataset is constructed, where each pixel of each underwater sonar segmentation image in this dataset includes a label.

Currently, datasets in the field of underwater acoustic object recognition are relatively scarce, and underwater acoustic sonar image object recognition and classification is a challenging problem. In this embodiment, the underwater sonar segmentation image is acquired by Tritech 1200i side-scan sonar. The underwater sonar segmentation image is in the form of a two-dimensional matrix of raw echo intensity information acquired by side-scan sonar, stored in bmp format with a resolution of 12,000×8,200 pixels.

S2: An adjustable effective receptive field U-shape network (AEU-Net) model is constructed and trained based on a U-shape network (U-Net).

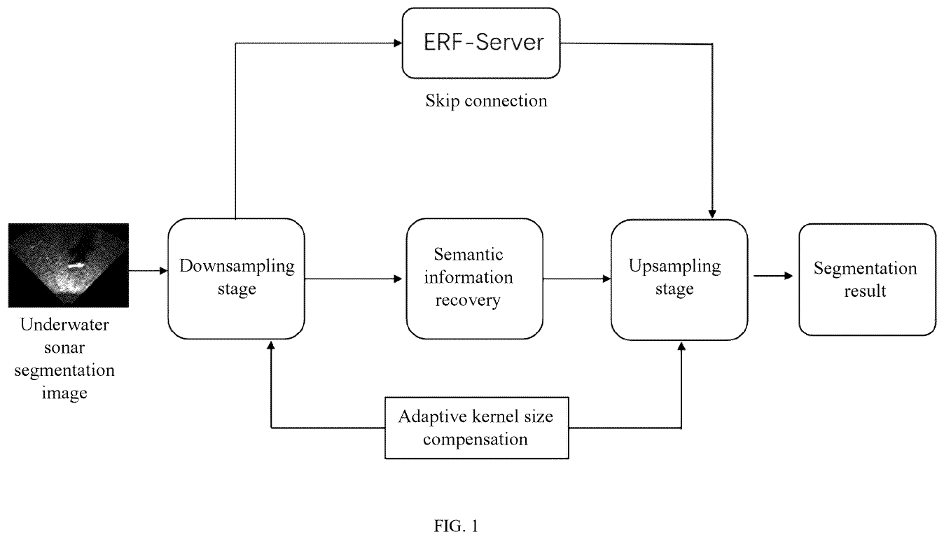

As shown in FIG. 1, the AEU-Net includes: a downsampling stage, an upsampling stage, and an ERF-Server network branch. An information interaction module of HRNet is used to expand each single-resolution module of the U-Net, such that the original module has two resolution branches, including a first branch at an original resolution and a second branch at ½ of the original resolution. The original image is input into the downsampling stage after passing through a preprocessing convolutional layer. In the downsampling stage, the output of each module is skip-connected to the corresponding upsampling module via the ERF-Server when transmitted to the next module. The ERF-Server specifically refers to the combined action of the two operations: U-Serve and D-Serve, to acquire the feature representation after the ERF changes. In the downsampling stage, adaptively-sized convolutional kernels are used for compensation during the downsampling process of each module. The outputs of each module in the upsampling stage are concatenated along the channel dimension. Thus, each upsampling stage has three sets of feature map sources (i.e., inputs): the upsampled output of the first branch in the previous module, the output of U-Serve in the ERF-Server, and the output of D-Serve in the ERF-Server. These three sets of feature maps are concatenated and fused along the channels according to channel allocation coefficient Cₖ. The channel allocation coefficient gives each of these three sets of feature maps a proportion summing to 1. The outputs of each upsampling module are concatenated. Without losing any channels, fused features including multi-scale information are acquired. Finally, a 1D convolution is performed, followed by the processing of a fully connected layer, to output the classification label and complete the recognition.

S2 is specifically achieved through following sub-steps.

S2.1: The information interaction module of the HRNet is embedded into the single-resolution modules of the U-Net (i.e., embedded into each module) to acquire a U-shape high-resolution feature extraction network with enhanced global information perception capability.

Specifically, the upsampling stage and the downsampling stage serve as a backbone network. The upsampling stage, the downsampling stage, and the semantic information recovery from skip connections all originate from the structure of the U-Net itself. The U-Net is used to extract features from the image. Before entering the backbone network, the original image is first input into a preprocessing convolutional layer, which downsamples the resolution to ¼ of the original image size, serving as the initial input to the backbone network. Each module in the downsampling stage reduces the resolution of the feature map by half stepwise through convolutional operations with a stride of 2. During this process, the semantic information gradually becomes lower-level and more abstract through convolution. It can increase robustness to small perturbations in the input image, such as image translation and rotation, reduce the risk of overfitting, decrease computational load, and increase the size of the receptive field. Skip connections use the output of a module in the downsampling stage as input to the corresponding module (referring to the module with the same resolution) in the upsampling stage.

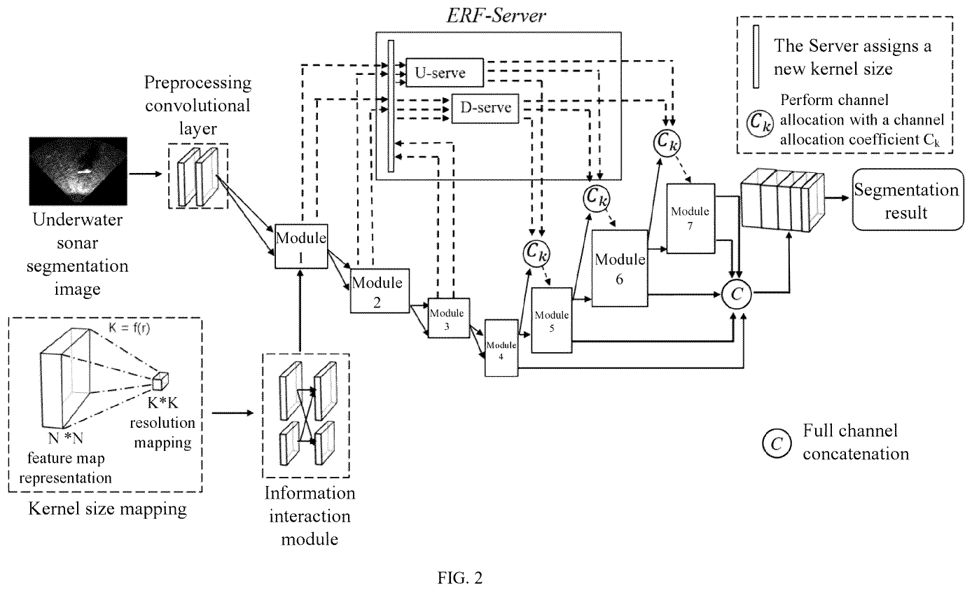

After the information interaction module of the HRNet is embedded into the single-resolution modules of the U-Net, each module includes two branches with adjacent resolutions (differing by a factor of ½), namely the first branch and the second branch. The forward propagation module in each branch is reconstructed with large-kernel convolution blocks, while the semantic information between adjacent resolution branches is reconstructed in the manner of HRNet information interaction, as shown in FIG. 2. The method for reducing the resolution is 3*3 residual block downsampling, and the method for increasing the resolution is bilinear interpolation.

As shown in FIG. 2, in this embodiment, module 1 is used as a first single-resolution module, and modules 2 to 7 are named sequentially. The downsampling stage includes modules 1 to 4, and the upsampling stage includes modules 4 to 7. The feature map with a resolution of ¼ after the preprocessing convolutional layer is split into two paths: one path input into the first branch of module 1 without any operation and the other path simultaneously downsampled to ⅛ (i.e., downsampled to half the original size) and input into the second branch of module 1. The two branches proceed in parallel. The two branches of each module undergo one cross-scale interaction. After interaction, they each pass through several large-kernel convolutions for output.

During the downsampling process, the output of the first branch in the previous module is input to the first branch of the corresponding resolution module in the upsampling stage via a skip connection. The output of the second branch in the previous module is split into two paths: one path input to the first branch in the next module after a convolution with a residual block of stride 1 and the other path input to the second branch in the next module after downsampling by a residual block of stride 2.

During the upsampling process, the output of the first branch in the previous module is upsampled and input to the first branch in the next module. The output of the first branch in the previous module is convolved with a residual block of stride 1 and serving as input to the second branch in the next module. In this embodiment, bilinear interpolation is used for upsampling. In this embodiment, the entire backbone network has 5 outputs: outputs of the second branches of the module 4, the module 5, the module 6, and the module 7, and output of the first branch of the module 7. The outputs of the second branches of each module in the upsampling stage are uniformly upsampled to the highest resolution, concatenated, then subjected to 1D convolution, and passed through the fully connected layer to output the classification result.

S2.2: For the U-shape high-resolution feature extraction network, the convolutional kernels in each branch in the backbone network, except for the ERF-Server, are further reconstructed using depth-wise convolution (DW conv). The DW conv has an adaptively-sized convolutional kernel, whose size has a positive correlation matching relationship with the resolution of each branch's feature map, thereby acquiring a new adaptive-kernel-size information interaction module for each module.

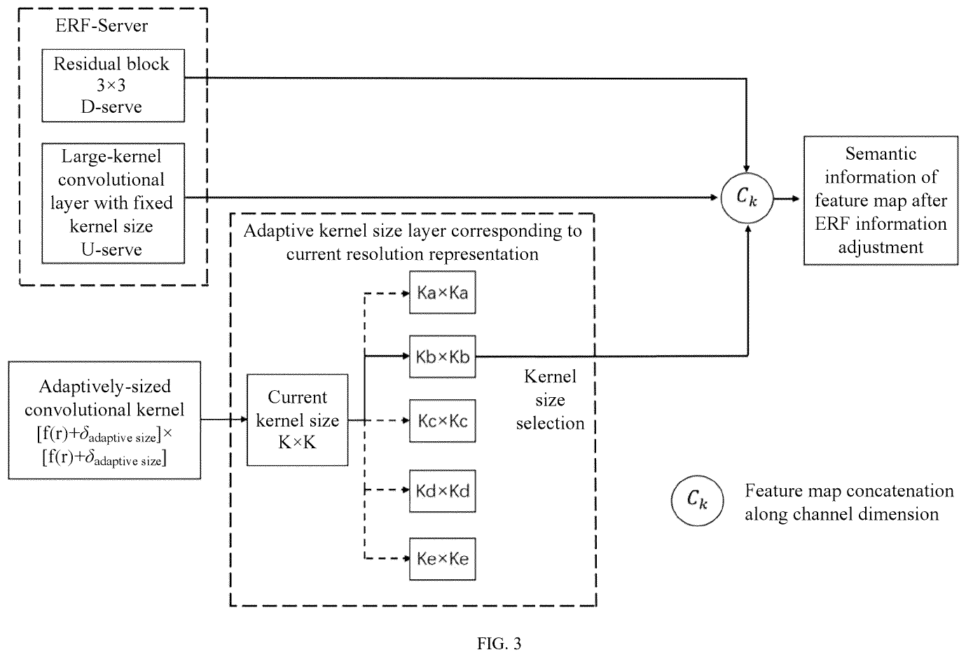

As shown in FIG. 3, unlike conventional convolution operations, in DW conv, one convolutional kernel is responsible for one channel, one channel is convolved by only one convolutional kernel, and the number of channels in the feature map after convolution equals the number of input channels. The adaptively-sized convolutional kernel controls the kernel size through its own loss function. This loss function is independent of the loss function for the convolutional parameters in the training module, and each resolution feature map's adaptively-sized convolutional kernel adjusts its own kernel size during training with the help of this function.

The specific update logic for the loss function of the adaptively-sized convolutional kernel during training is as follows. The loss function of the adaptively-sized convolutional kernel guides the adaptive convolutional kernel to select and update the size based on a difference between a predicted pixel and a pixel in the ground truth label for samples of different classes during each training.

Based on the update logic for the loss function of the adaptively-sized convolutional kernel during training, the objects to be recognized in the sonar segmentation image dataset are divided into two classes, large objects and small objects, according to manually added prior knowledge. If the corresponding loss function increases when the predicted pixels of a large object have mispositioning or insufficient filling compared to the ground truth label, it tends to reduce the loss function by increasing the kernel size, thereby iterating towards a larger kernel size. If the corresponding loss function increases when the predicted pixels of a small object presents missed detection or false determination compared to the ground truth label, it tends to reduce the loss function by decreasing the kernel size, thereby iterating towards a smaller kernel size. The loss function is expressed as follows:

loss~\sqrt{kₚ*prediction deviation of second object}+\sqrt{prediction deviation of first object−kₚ}

In the equation, kₚ denotes a dimensionally normalized value for a prediction deviation between the size of the adaptive convolutional kernel in the current module and the first object as well as the second object; and ~ denotes a positive correlation. It should be noted that both terms are meaningful only when the expression under the square root is positive. Otherwise, they are 0. This operation logic is specifically implemented using a rectified linear unit (relu) function.

The small-object prediction deviation is expressed by a Hausdorff distance, specifically as follows:

Hausdorff(A,B)=max{h(A,B),h(B,A)}

h(A,B)=max_{a∈A} min_{b∈B}∥a−b∥

h(B,A)=max_{b∈A} min_{a∈B}∥b−a∥

The large-object prediction deviation is expressed by a Dice coefficient, specifically as follows:

$$Dice = \frac{2 \times \vert A ⋂ B \vert}{\vert A \vert + \vert B \vert}$$

In the equations, A={a1, a2, . . . , ap}, B={b1, b2, . . . , bp}; A is a predicted pixel set; B is a ground truth label pixel set; and ∥a−b∥ denotes a Euclidean distance between two pixels.

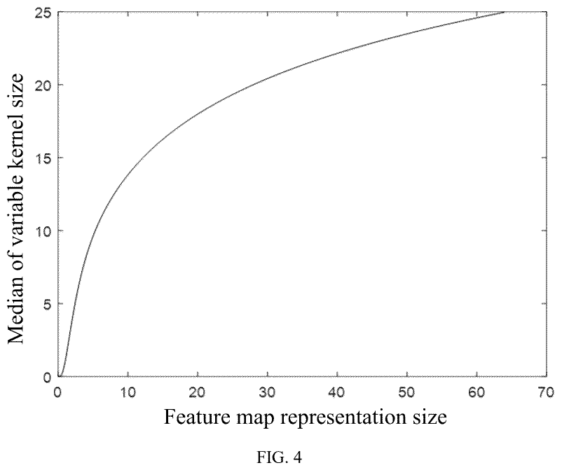

The size of the adaptive convolutional kernel is an integer, positively correlated with the resolution of the current module's feature map. It is adjustable within a preset kernel size interval, and the median intervals of the kernel sizes used by adaptive convolutional kernels for different resolutions feature maps do not overlap. Furthermore, the medians of these kernel size intervals are determined by a size function. In the actual model training process, the size change is reflected in selecting one size from a set of sizes for use after each update. The correspondence between the median of the kernel size interval for the adaptive convolutional kernel and the representation size of the feature map is shown in FIG. 4. The size function is expressed as follows:

$${k}_{m} = f ( r )$$

$$f ( r ) = \frac{2 ln ( {r}^{3} + 1 )}{1 + {e}^{- r}}$$

In the equations, kₘ denotes the median of the kernel size interval for the adaptive convolutional kernel; f(r) denotes the size function; and r denotes a size of the feature map representation of the current module.

S2.3: For the reconstructed adaptive kernel size information interaction module, the network branch module ERF-Server is constructed to achieve skip connections, completing the construction of the AEU-Net model. The main function of the ERF-Server is to take some ERF information from the model, process it into desired features, and send it back to the model. As shown in FIG. 2, in this embodiment, the outputs of the module 1, the module 2, and the module 3 are input to the ERF-Server network branch. The output of the module 1 is correspondingly input to the module 7, the output of the module 2 is correspondingly input to the module 6, and the output of the module 3 is correspondingly input to the module 5.

As shown in FIG. 3, the ERF-Server receives acoustic semantic information from different modules in the downsampling stage of the model and performs two different operations to acquire acoustic semantic information at different ERF scales.

Large ERF semantic information is acquired through an operation called U-Serve and skip-connected and concatenated into subsequent modules. U-Serve refers to a network branch including multiple DW convs with fixed kernel sizes (set to the maximum value within the variable range for the convolutional kernel size of the highest-resolution branch) and residual connections. It can receive features from any module in the downsampling stage. After processing by the large kernel convolution of U-Serve, feature map semantic information with a significantly increased ERF compared to the original 3*3 residual block is acquired. The result is adjusted for the number of channels using a 1*1 residual block and then concatenated into subsequent specified modules according to the channel allocation, allowing that module to acquire new semantic information from the feature map with increased ERF information, further improving the richness of ERF information across all channels. The channel allocation is implemented with channel allocation coefficient Cₖ, making the fusion efficiency of the new semantic information in the module adjustable.

Small ERF semantic information is acquired through an operation called D-Serve and skip-connected and concatenated into subsequent modules. D-Serve refers to a network branch including a fixed number of residual blocks. It can receive features from any module in the downsampling stage. Due to its relatively fewer convolutional layers compared to the backbone network, it retains features with smaller early ERFs in the acoustic frequency domain signal. The result is adjusted for the number of channels using a 1*1 residual block and then concatenated into subsequent specified modules according to the channel allocation, allowing that module to acquire new semantic information from this feature map with reduced ERF information, further improving the richness of ERF information across all channels. Since the channel allocation is implemented with the allocation coefficient, the fusion efficiency of the new semantic information is adjustable. In this embodiment, D-serve processes the received information through 3*3 residual blocks. Compared to the backbone branch using large kernel groups, D-serve controls the rapid increase of the ERF, enabling the model to capture the current scale's ERF information more deeply.

It is important to note that at the output end of the ERF-Server, both U-serve and D-serve undergo channel allocation with the upsampled result of the first branch in the previous module of the corresponding module of the backbone network. The original channels are replaced with new channels processed by the ERF-Server operation according to the channel allocation coefficient, thereby acquiring the feature representation after the ERF change. The channel allocation is implemented through the channel allocation coefficient Cₖ. The channel allocation coefficient Cₖ is a preset hyperparameter, a 1*3 vector. Each component is between 0 and 1 and sums to 1, representing the respective proportions of three feature maps from the output of D-Serve, the output of U-Serve, and the upsampled output of the first branch in the previous module of the corresponding module in the upsampling stage. Rounding is applied to a number of channels during allocation. The hyperparameter is a real number, increasing the variability of parameter tuning. A larger value assigned to D-Serve and U-Serve by Cₖ means the corresponding Server plays a stronger role. Conversely, 0 means the Server has no effect.

S2.4: The underwater sonar segmentation image dataset is input into the AEU-Net for training to acquire the trained AEU-Net. During training, the size of the adaptively-sized convolutional kernel is adjustable within the preset kernel size interval of the current module's feature map. The training goal is to minimize the loss function of the adaptively-sized convolutional kernel. For the feature representation after the ERF change acquired by the ERF-Server, the actual ERF is calculated using the size of the adaptively-sized convolutional kernel in each branch and the number of convolutional layers the branch passes through as follows:

$$\sqrt{Var [ Sn ]} = \sqrt{n ( {\sum }_{i = 0}^{k - 1} {\sum }_{j = 0}^{k - 1} ( {i}^{2} + {j}^{2} ) \cdot \frac{1}{{k}^{2}} - {( {\sum }_{i = 0}^{k - 1} {\sum }_{j = 0}^{k - 1} i \cdot \frac{1}{k} )}^{2} - {( {\sum }_{i = 0}^{k - 1} {\sum }_{j = 0}^{k - 1} j \cdot \frac{1}{k} )}^{2} )}$$

That is,

ERF~k\sqrt{n}

In the equation, \sqrt{Var[Sₙ]} denotes a standard deviation of pixel value Sₙ output by an n-th convolutional layer; Sₙ is constituted by a weighted sum of all input pixel values within its receptive field, and its variance is calculated by considering the contribution of each element in the adaptively-sized convolutional kernel to each output pixel; (i, j) denotes an index of an element in an i-th row and a j-th column of the k×k adaptively-sized convolutional kernel; the ERF in the equation denotes the ERF of the feature map of each module, where k denotes the size of the adaptively-sized convolutional kernel for convolving the feature map of each module for an underwater acoustic object signal; and n denotes a cumulative number of stacked layers from the input of the original image to a current convolutional layer.

While the kernel size is adjusted during training, the ERF distribution of each module in the entire AEU-Net model is acquired and serving as the ERF distribution optimized for the information distribution of the sonar segmentation image dataset.

S3: An underwater sonar segmentation image to be tested is input into the trained AEU-Net model to acquire a recognition result.

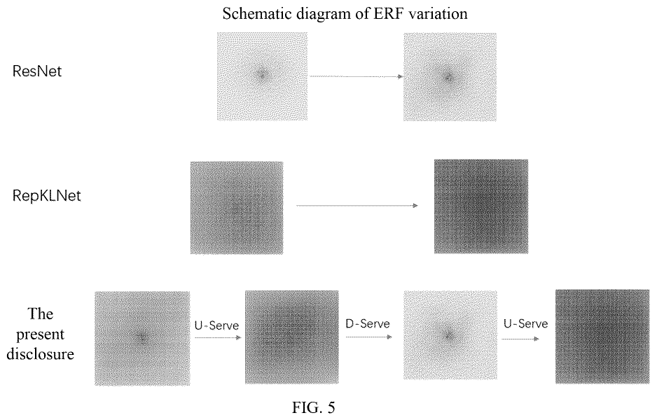

FIG. 5 is a schematic diagram comparing the effect of the ERF-Server framework in the present disclosure on changing the ERF attributes of feature maps during forward propagation through feature map concatenation with ResNet and RepLKNet. In the figure, the first row shows the ERF change between consecutive modules in existing ResNet, the second row shows the ERF change between consecutive modules in existing RepLKNet, and the third row shows the ERF calculated from all channel feature maps of a certain module selected in the AEU-Net model proposed by the present disclosure, which is then input into the ERF-Server for ERF adjustment testing. A darker color in the figure shows a greater influence on each pixel value starting from the center, i.e., a larger ERF, reflecting the size of the ERF based on color intensity. This illustrates the effectiveness of the ERF-Server in the present disclosure in adjusting the ERF.

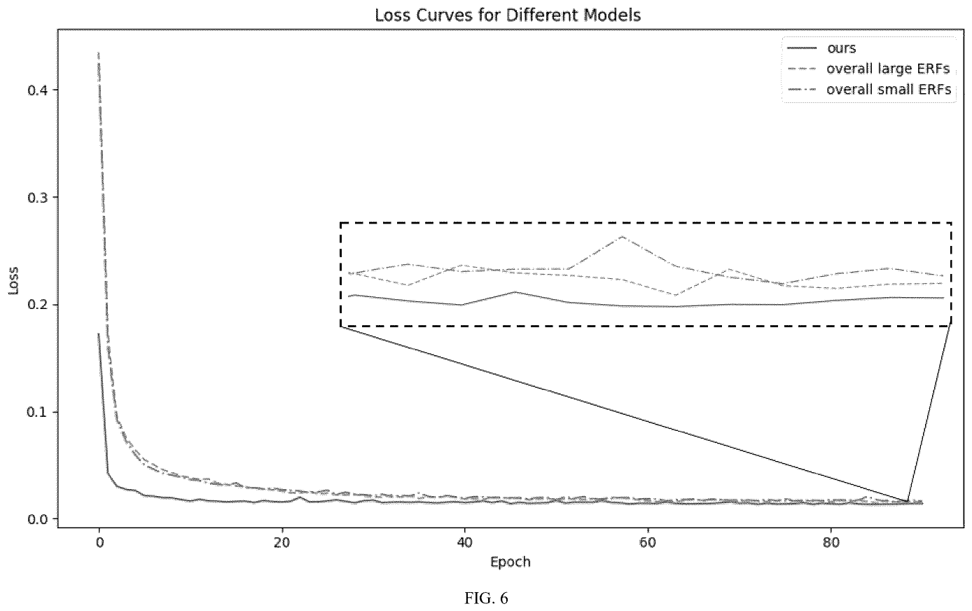

The binary classification salient object detection performance of the model is compared. FIG. 6 shows the loss comparison between the present disclosure and the situation without ERF adjustment. In the figure, “Overall small ERFs” represents a version of the model in this text that uses 3*3 large-kernel convolutional residual blocks throughout and removes the ERF-Server component. “Overall large ERFs” represents a version of the model in this text that uses 27*27 large-kernel convolutional residual blocks throughout and removes the ERF-Server component. “Ours” represents the model described in the present disclosure.

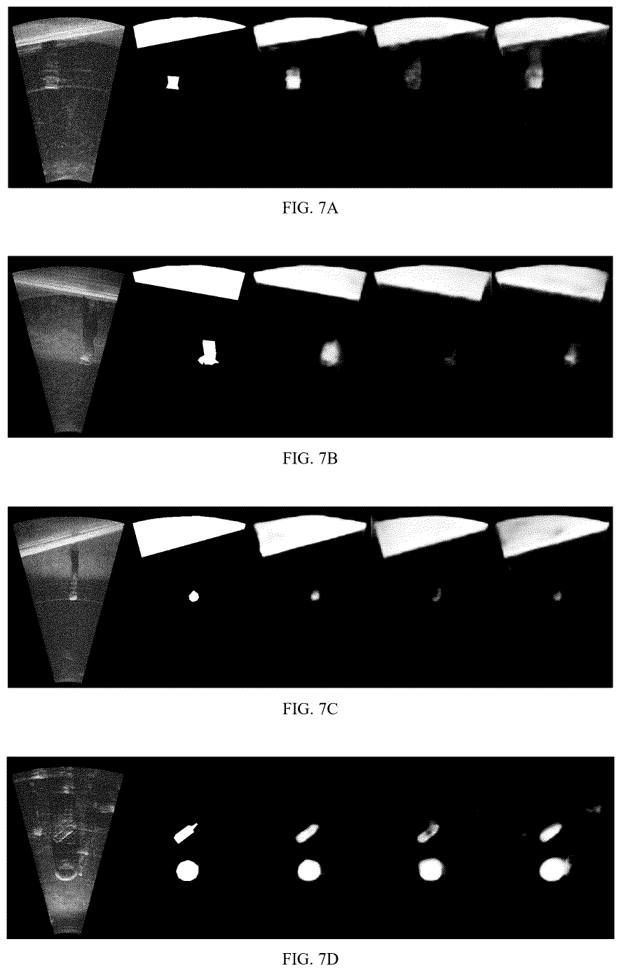

11 types of objects in the marine-debris-fls dataset are merged into one class for object-background binary classification. After 90 epochs of training, the visualized results are compared, as shown in FIGS. 7A-7D. FIGS. 7A-7D are examples of 4 different samples from the marine-debris-fls dataset, showing the imaging effects of different marine debris in forward-looking sonar. From left to right, the effect diagrams of each sample are: the original image, the ground truth label image, the output of the Ours model, the output of the Overall small ERFs model, and the output of the Overall large ERFs model. The model output and performance are displayed using saliency maps. The white color in the grayscale map represents the probability of a pixel being classified as the object, and a darker color indicates a greater probability that this pixel is classified as the object. It can be seen from the figure that the output of the model of the present disclosure has better adaptability to objects of different sizes. In the first three sample examples, as shown in FIG. 7A-7C, the model of the present disclosure not only produces clearer boundaries when recognizing large objects but also successfully recognizes the overall shape of small objects, while other methods cannot recognize small objects well. In the fourth sample example, as shown in FIG. 7D, with only small objects present, the model of the present disclosure still produces the clearest recognition result and has no background noise, whereas in the Overall large ERFs model, a small amount of white noise is generated in the background, mistakenly judged as the object.

Furthermore, a multi-class semantic segmentation performance comparison is conducted for the model of the present disclosure. Tables 1-1 and 1-2 below show the performance comparison with different state-of-the-art models in the multi-class semantic segmentation scenario. The multi-class pixel-level annotation of the dataset follows the default settings of the marine-debris-fls dataset, with a total of 12 classes. Mean intersection over union (MIoU) and mean pixel accuracy (MPA) are used as metrics.

TABLE 1-1
Multi-class Semantic Segmentation Performance Comparison
Table 1 of Different State-of-the-art Models

| Class | FCN | Unet | PSPNet | RefineNet | Deeplabv3+ | Unet++ | ANNNet | CCNet |
|---|---|---|---|---|---|---|---|---|
| Background | 0.98 | 0.99 | 0.99 | 0.99 | 0.99 | 0.99 | 0.99 | 0.99 |
| Bottle | 0.78 | 0.82 | 0.79 | 0.8 | 0.81 | 0.79 | 0.81 | 0.83 |
| Can | 0.57 | 0.53 | 0.56 | 0.62 | 0.58 | 0.61 | 0.61 | 0.62 |
| Chain | 0.57 | 0.68 | 0.55 | 0.66 | 0.64 | 0.65 | 0.57 | 0.67 |
| Drink carton | 0.67 | 0.81 | 0.74 | 0.78 | 0.79 | 0.78 | 0.72 | 0.78 |
| Hook | 0.67 | 0.68 | 0.57 | 0.69 | 0.7 | 0.72 | 0.6 | 0.73 |
| Propeller | 0.58 | 0.76 | 0.69 | 0.74 | 0.73 | 0.74 | 0.54 | 0.77 |
| Shampoo | 0.76 | 0.82 | 0.76 | 0.81 | 0.82 | 0.83 | 0.8 | 0.81 |
| bottle | | | | | | | | |
| Standing | 0.47 | 0.47 | 0.42 | 0.46 | 0.46 | 0.48 | 0.44 | 0.45 |
| bottle | | | | | | | | |
| Tyre | 0.56 | 0.88 | 0.86 | 0.9 | 0.88 | 0.9 | 0.87 | 0.89 |
| Valve | 0.88 | 0.56 | 0.37 | 0.61 | 0.58 | 0.64 | 0.47 | 0.56 |
| Wall | 0.81 | 0.88 | 0.86 | 0.87 | 0.87 | 0.85 | 0.8 | 0.87 |
| MIoU | 0.696 | 0.74 | 0.679 | 0.745 | 0.738 | 0.752 | 0.691 | 0.748 |
| MPA | 0.803 | 0.852 | 0.799 | 0.853 | 0.887 | 0.876 | 0.782 | 0.848 |

TABLE 1-2
Multi-class Semantic Segmentation Performance Comparison
Table 2 of Different State-of-the-art Models

| | | | | Swin- | | Swin- | MT- | | |
|---|---|---|---|---|---|---|---|---|---|
| Class | DFANet | DANet | UNet3+ | transformer | TransUNet | Unet | Unet | DDRNet | Ours |
| Background | 0.99 | 0.99 | 0.99 | 0.99 | 0.99 | 0.99 | 0.99 | 0.99 | 0.99 |
| Bottle | 0.77 | 0.81 | 0.79 | 0.83 | 0.66 | 0.82 | 0.83 | 0.79 | 0.82 |
| Can | 0.61 | 0.65 | 0.61 | 0.69 | 0.69 | 0.55 | 0.59 | 0.6 | 0.65 |
| Chain | 0.63 | 0.67 | 0.68 | 0.65 | 71 | 0.63 | 0.67 | 0.65 | 0.66 |
| Drink carton | 0.7 | 0.76 | 0.77 | 0.76 | 0.73 | 0.79 | 0.81 | 0.77 | 0.79 |
| Hook | 0.61 | 0.72 | 0.72 | 0.7 | 0.58 | 0.71 | 0.72 | 0.73 | 0.73 |
| Propeller | 0.63 | 0.75 | 0.74 | 0.76 | 0.71 | 0.77 | 0.71 | 0.72 | 0.75 |
| Shampoo | 0.77 | 0.81 | 0.83 | 0.83 | 0.77 | 0.83 | 82 | 0.82 | 0.83 |
| bottle | | | | | | | | | |
| Standing | 0.44 | 0.45 | 0.47 | 0.48 | 0.32 | 0.48 | 0.46 | 0.47 | 0.73 |
| bottle | | | | | | | | | |
| Tyre | 0.86 | 0.88 | 0.91 | 0.88 | 0.9 | 0.89 | 0.9 | 0.9 | 0.89 |
| Valve | 0.53 | 0.62 | 0.62 | 0.6 | 0.43 | 0.6 | 0.63 | 0.63 | 0.63 |
| Wall | 0.82 | 0.86 | 0.87 | 0.88 | 0.88 | 0.88 | 0.88 | 0.87 | 0.9 |
| MIoU | 0.697 | 0.748 | 0.75 | 0.753 | 0.698 | 0.745 | 0.752 | 0.746 | 0.78 |
| MPA | 0.805 | 0.856 | 0.87 | 0.859 | 0.825 | 0.873 | 0.878 | 0.878 | 0.88 |

In the above tables, ANNNet stands for asymmetric non-local neural networks, CCNet stands for criss-cross attention network, DFANet stands for deep feature aggregation, DANet stands for dual attention network, MT-Unet stands for mixed transformer U-Net, and DDRNet stands for deep dual-resolution. The MIOU for each class of object and the overall MIOU for all classes of all models are compared. Additionally, the overall MPA for all classes is compared in the last row.

Compared to existing segmentation network methods applied in this field, the underwater acoustic object recognition method based on an adjustable ERF provided by the present disclosure possesses a larger and more rapidly changing ERF brought by large kernel convolutions and thus possesses more ERF resources. This enables the network to have a stronger global feature capture capability for defect samples through the interaction of multi-scale ERF information and to focus more on the overall shape of the defect when extracting information. On the other hand, it has an independent branch framework, ERF-Server, which can actively adjust the change in the network's ERF. The functionality of this module benefits from the large-kernel operation of U-serve, which can rapidly enhance the original ERF. Furthermore, since the sizes of the adaptive convolutional kernels in the backbone network are all larger than the traditional 3*3 convolution, using 3*3 residual blocks in D-serve can reduce the ERF compared to the backbone network, allowing the full utilization of ERF information from small to large scales in the underwater sonar segmentation images initially input into the AEU-Net. The present disclosure can overall improve the recognition accuracy on underwater sonar datasets while reducing the model parameter count by nearly half compared to the original U-Net and HRNet to meet the real-time requirements of underwater object recognition.

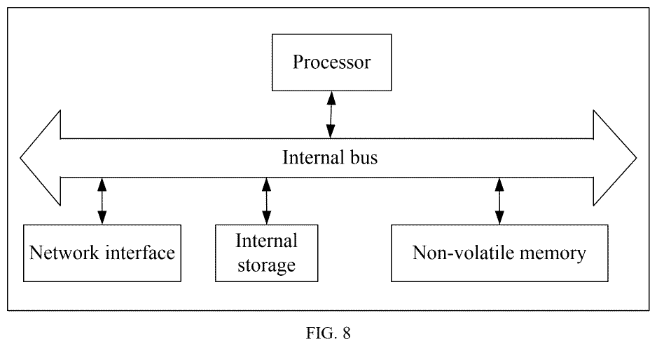

As shown in FIG. 8, an embodiment of the present disclosure provides an electronic device, including: a memory and at least one processor. The memory is configured to store an executable code. The executable code is executed by the at least one processor to implement the underwater acoustic object recognition method based on an adjustable ERF in the above embodiment.

The device of the present disclosure can be applied to any device with data processing capabilities, such as a computer or other similar apparatuses or devices. The device of the present disclosure can be implemented through software, hardware, or a combination of software and hardware. Using software implementation as an example, as a logical device, it is formed by reading, by a processor of a device with data processing capabilities where the device is located, corresponding computer program instructions from a non-volatile memory into a memory for running. From a hardware perspective, FIG. 8 is a hardware structure diagram of a device with a data processing capability in the present disclosure. In addition to the processor, internal storage, network interface, and non-volatile memory shown in FIG. 8, the device with a data processing capability, where the device of the embodiment is located, may typically include other hardware based on the actual functionality of the device with a data processing capability, and details are not described herein.

The specific implementation process of the functions and roles of each unit in the above device is detailed in the corresponding steps of the foregoing method and is not described herein again.

For the device embodiment, since it substantially corresponds to the method embodiment, it is sufficient to refer to a part of the description of the method embodiment where relevant. The device embodiments described above are merely examples, where units described as separate components may or may not be physically separated. Components displayed as units may or may not be physical units, that is, the components may be located in one place, or may be distributed to a plurality of network units. Some or all of its modules may be selected according to actual needs to implement the solutions of the present disclosure. Those of ordinary skill in the art can understand and implement the embodiments without creative effort.

An embodiment of the present disclosure further provides a computer-readable storage medium for storing a program. The program is executed by a processor to implement the underwater acoustic object recognition method based on an adjustable ERF in the above embodiment.

The computer-readable storage medium may be an internal storage unit of the device with a data processing capability described in any of the above-mentioned embodiments, such as a hard disk or an internal storage. The computer-readable storage medium may alternatively be an external storage device of the device with data processing capabilities, such as a plug-in hard disk, a smart media card (SMC), a secure digital (SD) card, or a flash card equipped on the device. Further, the computer-readable storage medium may also include both the internal storage unit and the external storage device of the device with a data processing capability. The computer-readable storage medium is configured to store the computer program and another program and data that are required by the device with a data processing capability, and may further be configured to temporarily store data that is output or to be output.

A person of ordinary skill in the art may understand that the above descriptions are only preferred embodiments of the present disclosure and are not intended to limit the present disclosure. Although the present disclosure is described in detail with reference to the foregoing embodiments, a person skilled in the art can still make modifications to the technical solutions described in the foregoing embodiments, or make equivalent replacement to some technical characteristics. Any modifications and equivalent substitutions made within the spirit and scope of the present disclosure should be included within the protection scope of the present disclosure.

1. An underwater acoustic object recognition method based on an adjustable effective receptive field (ERF), comprising following steps:
S1: constructing a pixel-wise-labeled underwater sonar segmentation image dataset;
S2: constructing and training an adjustable effective receptive field U-shape network (AEU-Net) model based on a U-shape network (U-Net), specifically comprising following sub-steps:
S2.1: embedding an information interaction module of a high-resolution network (HRNet) into each single-resolution module of the U-Net, and expanding each module into first and second resolution branches; downsampling an original image after the original image passes through a preprocessing convolutional layer; inputting, in a downsampling stage, an output of the first branch in a previous module to the first branch of a corresponding module in an upsampling stage via a skip connection, wherein the corresponding module is determined based on feature maps of an identical resolution; splitting an output of the second branch in the previous module into two paths: one convolved through a residual block with a stride of 1 and serving as an input for the first branch in a next module and the other downsampled through a residual block with a stride of 2 and serving as an input for the second branch in the next module; upsampling and inputting, during an upsampling process, an output of the first branch in the previous module to the first branch in the next module; convolving the output of the first branch in the previous module through a residual block with a stride of 1 to form an input for the second branch in the next module; and concatenating the outputs of the second branches of each module in the upsampling stage along a channel dimension, and outputting a classification label after sequentially performing one-dimensional (1D) convolution and processing through a fully connected layer;
S2.2: reconstructing convolutional kernels in each branch by depth-wise convolution (DW conv), wherein DW conv is implemented through an adaptively-sized convolutional kernel with a size matching with the resolution of the feature map of each branch;
S2.3: constructing an ERF-Server network branch to implement the skip connection, and completing the construction of the AEU-Net model, wherein the ERF-Server network branch comprises two operations: U-Serve and D-Serve: acquiring, for a feature map representation output by each module during downsampling, new semantic information with an increased ERF after processing by a large-kernel convolution block of U-Serve; acquiring, for the feature map representation output by each module during downsampling, new semantic information with a reduced ERF after processing by a fixed-size 3*3 residual convolution block of D-Serve; and concatenating an upsampled output of the first branch in the previous module of the corresponding module in the upsampling stage with an output of U-Serve and an output of D-Serve into the corresponding module in the upsampling stage according to a channel allocation coefficient; and
S2.4: inputting the underwater sonar segmentation image dataset into the AEU-Net for training, and acquiring a trained AEU-Net model, wherein during training, the size of the adaptively-sized convolutional kernel is adjustable within a preset kernel size interval for the feature map of a current module; and a training goal is to minimize a loss function of the adaptively-sized convolutional kernel; and
S3: inputting an underwater sonar segmentation image to be tested into the trained AEU-Net model, and acquiring a recognition result.

2. The underwater acoustic object recognition method based on the adjustable ERF according to claim 1, wherein in the step S2.2, in DW conv, one convolutional kernel is responsible for one channel, one channel is convolved by only one convolutional kernel, and a number of channels in the feature map after convolution equals a number of input channels; and the adaptively-sized convolutional kernel controls the size through the loss function.

3. The underwater acoustic object recognition method based on the adjustable ERF according to claim 2, wherein update logic for the loss function of the adaptively-sized convolutional kernel during training is as follows: the loss function of the adaptively-sized convolutional kernel guides the adaptive convolutional kernel to select and update the size based on a difference between a predicted pixel and a pixel in a ground truth label for samples of different classes during each training;
based on the update logic for the loss function of the adaptively-sized convolutional kernel during training, objects to be recognized in the underwater sonar segmentation image dataset are divided into two classes: a first object and a second object; if the corresponding loss function increases when a predicted pixel of the first object presents mispositioning or insufficient filling compared to the ground truth label, the loss function is reduced by increasing the size of the adaptive convolutional kernel; if the corresponding loss function increases when a predicted pixel of the second object presents missed detection or false determination compared to the ground truth label, the loss function is reduced by decreasing the size of the adaptive convolutional kernel; and the loss function is expressed as follows:
loss~\sqrt{kₚ*prediction deviation of second object}+\sqrt{prediction deviation of first object−kₚ}
wherein, kₚ denotes a dimensionally normalized value for a prediction deviation between the size of the adaptive convolutional kernel in the current module and the first object as well as the second object.

4. The underwater acoustic object recognition method based on the adjustable ERF according to claim 3, wherein a small-object prediction deviation is expressed by a Hausdorff distance, specifically as follows:
Hausdorff(A,B)=max{h(A,B),h(B,A)}
h(A,B)=max_{a∈A} min_{b∈B}∥a−b∥
h(B,A)=max_{b∈A} min_{a∈B}∥b−a∥
a large-object prediction deviation is expressed by a Dice coefficient, specifically as follows:
$$Dice = \frac{2 \times \vert A ⋂ B \vert}{\vert A \vert + \vert B \vert}$$
wherein, A={a¹, a², . . . , a^{p}}, and B={b¹, b², . . . , b^{p}}; A is a predicted pixel set; B is a ground truth label pixel set; and ∥a−b∥ denotes a Euclidean distance between two pixels.

5. The underwater acoustic object recognition method based on the adjustable ERF according to claim 1, wherein the size of the adaptive convolutional kernel is adjustable within the preset kernel size interval for the feature map of the current module, and kernel size intervals corresponding to feature maps of different resolutions do not overlap; and the kernel size interval is determined by a size function expressed as follows:
$${k}_{m} = f ( r )$$
$$f ( r ) = \frac{2 ln ( {r}^{3} + 1 )}{1 + {e}^{- r}}$$
wherein, kₘ denotes a median of the kernel size interval for the adaptive convolutional kernel; f(r) denotes the size function; and r denotes a size of the feature map representation of the current module.

6. The underwater acoustic object recognition method based on the adjustable ERF according to claim 1, wherein upsampling is implemented through bilinear interpolation.

7. The underwater acoustic object recognition method based on the adjustable ERF according to claim 1, wherein in the step S2.3, the channel allocation is implemented through the channel allocation coefficient denoted as Cₖ; the channel allocation coefficient Cₖ is a preset hyperparameter, a 1*3 vector; each component is between 0 and 1 and sums to 1, representing proportions of three feature maps from the output of D-Serve, the output of U-Serve, and the upsampled output of the first branch in the previous module of the corresponding module in the upsampling stage; and rounding is applied to a number of channels during allocation.

8. The underwater acoustic object recognition method based on the adjustable ERF according to claim 1, wherein the step S2.4 comprises: acquiring an ERF distribution of the feature maps of each module in the entire AEU-Net model; and calculating an actual ERF based on the size of the adaptively-sized convolutional kernel in each branch and a number of convolutional layers the branch passes through as follows:
$$\sqrt{Var [ Sn ]} = \sqrt{n ( {\sum }_{i = 0}^{k - 1} {\sum }_{j = 0}^{k - 1} ( {i}^{2} + {j}^{2} ) \cdot \frac{1}{{k}^{2}} - {( {\sum }_{i = 0}^{k - 1} {\sum }_{j = 0}^{k - 1} i \cdot \frac{1}{k} )}^{2} - {( {\sum }_{i = 0}^{k - 1} {\sum }_{j = 0}^{k - 1} j \cdot \frac{1}{k} )}^{2} )}$$
that is,
ERF~k\sqrt{n}
wherein, \sqrt{Var[Sₙ]} denotes a standard deviation of a pixel value Sₙ output by an n-th convolutional layer; (i, j) denotes an index of an element in an i-th row and a j-th column of the k×k adaptively-sized convolutional kernel; k denotes the size of the adaptively-sized convolutional kernel for convolving the feature map of each module for an underwater acoustic object signal; and n denotes a cumulative number of stacked layers from the input of the original image to a current convolutional layer.

9. An electronic device, comprising: a memory and at least one processor, wherein the memory is configured to store an executable code; and the executable code is executed by the at least one processor to implement the underwater acoustic object recognition method based on the adjustable ERF according to claim 1.

10. A computer-readable storage medium, configured to store a program, wherein the program is executed by a processor to implement the underwater acoustic object recognition method based on the adjustable ERF according to claim 1.

11. The electronic device according to claim 9, wherein in the step S2.2, in DW conv, one convolutional kernel is responsible for one channel, one channel is convolved by only one convolutional kernel, and a number of channels in the feature map after convolution equals a number of input channels; and the adaptively-sized convolutional kernel controls the size through the loss function.

12. The electronic device according to claim 11, wherein update logic for the loss function of the adaptively-sized convolutional kernel during training is as follows: the loss function of the adaptively-sized convolutional kernel guides the adaptive convolutional kernel to select and update the size based on a difference between a predicted pixel and a pixel in a ground truth label for samples of different classes during each training;
based on the update logic for the loss function of the adaptively-sized convolutional kernel during training, objects to be recognized in the underwater sonar segmentation image dataset are divided into two classes: a first object and a second object; if the corresponding loss function increases when a predicted pixel of the first object presents mispositioning or insufficient filling compared to the ground truth label, the loss function is reduced by increasing the size of the adaptive convolutional kernel; if the corresponding loss function increases when a predicted pixel of the second object presents missed detection or false determination compared to the ground truth label, the loss function is reduced by decreasing the size of the adaptive convolutional kernel; and the loss function is expressed as follows:
loss~\sqrt{kₚ*prediction deviation of second object}+\sqrt{prediction deviation of first object−kₚ}
wherein, kₚ denotes a dimensionally normalized value for a prediction deviation between the size of the adaptive convolutional kernel in the current module and the first object as well as the second object.

13. The electronic device according to claim 12, wherein a small-object prediction deviation is expressed by a Hausdorff distance, specifically as follows:
Hausdorff(A,B)=max{h(A,B),h(B,A)}
h(A,B)=max_{a∈A} min_{b∈B}∥a−b∥
h(B,A)=max_{b∈A} min_{a∈B}∥b−a∥
a large-object prediction deviation is expressed by a Dice coefficient, specifically as follows:
$$Dice = \frac{2 \times \vert A ⋂ B \vert}{\vert A \vert + \vert B \vert}$$
wherein, A={a¹, a², . . . , a^{p}}, and B={b¹, b², . . . , b^{p}}; A is a predicted pixel set; B is a ground truth label pixel set; and ∥a−b∥ denotes a Euclidean distance between two pixels.

14. The electronic device according to claim 9, wherein the size of the adaptive convolutional kernel is adjustable within the preset kernel size interval for the feature map of the current module, and kernel size intervals corresponding to feature maps of different resolutions do not overlap; and the kernel size interval is determined by a size function expressed as follows:
$${k}_{m} = f ( r )$$
$$f ( r ) = \frac{2 ln ( {r}^{3} + 1 )}{1 + {e}^{- r}}$$
wherein, kₘ denotes a median of the kernel size interval for the adaptive convolutional kernel; f(r) denotes the size function; and r denotes a size of the feature map representation of the current module.

15. The electronic device according to claim 9, wherein upsampling is implemented through bilinear interpolation.

16. The electronic device according to claim 9, wherein in the step S2.3, the channel allocation is implemented through the channel allocation coefficient denoted as Cₖ; the channel allocation coefficient Cₖ is a preset hyperparameter, a 1*3 vector; each component is between 0 and 1 and sums to 1, representing proportions of three feature maps from the output of D-Serve, the output of U-Serve, and the upsampled output of the first branch in the previous module of the corresponding module in the upsampling stage; and rounding is applied to a number of channels during allocation.

17. The electronic device according to claim 9, wherein the step S2.4 comprises: acquiring an ERF distribution of the feature maps of each module in the entire AEU-Net model; and calculating an actual ERF based on the size of the adaptively-sized convolutional kernel in each branch and a number of convolutional layers the branch passes through as follows:
$$\sqrt{Var [ Sn ]} = \sqrt{n ( {\sum }_{i = 0}^{k - 1} {\sum }_{j = 0}^{k - 1} ( {i}^{2} + {j}^{2} ) \cdot \frac{1}{{k}^{2}} - {( {\sum }_{i = 0}^{k - 1} {\sum }_{j = 0}^{k - 1} i \cdot \frac{1}{k} )}^{2} - {( {\sum }_{i = 0}^{k - 1} {\sum }_{j = 0}^{k - 1} j \cdot \frac{1}{k} )}^{2} )}$$
that is,
ERF~k\sqrt{n}
wherein, \sqrt{Var[Sₙ]} denotes a standard deviation of a pixel value Sₙ output by an n-th convolutional layer; (i, j) denotes an index of an element in an i-th row and a j-th column of the k×k adaptively-sized convolutional kernel; k denotes the size of the adaptively-sized convolutional kernel for convolving the feature map of each module for an underwater acoustic object signal; and n denotes a cumulative number of stacked layers from the input of the original image to a current convolutional layer.

18. The computer-readable storage medium according to claim 10, wherein in the step S2.2, in DW conv, one convolutional kernel is responsible for one channel, one channel is convolved by only one convolutional kernel, and a number of channels in the feature map after convolution equals a number of input channels; and the adaptively-sized convolutional kernel controls the size through the loss function.

19. The computer-readable storage medium according to claim 18, wherein update logic for the loss function of the adaptively-sized convolutional kernel during training is as follows: the loss function of the adaptively-sized convolutional kernel guides the adaptive convolutional kernel to select and update the size based on a difference between a predicted pixel and a pixel in a ground truth label for samples of different classes during each training;
based on the update logic for the loss function of the adaptively-sized convolutional kernel during training, objects to be recognized in the underwater sonar segmentation image dataset are divided into two classes: a first object and a second object; if the corresponding loss function increases when a predicted pixel of the first object presents mispositioning or insufficient filling compared to the ground truth label, the loss function is reduced by increasing the size of the adaptive convolutional kernel; if the corresponding loss function increases when a predicted pixel of the second object presents missed detection or false determination compared to the ground truth label, the loss function is reduced by decreasing the size of the adaptive convolutional kernel; and the loss function is expressed as follows:
loss~\sqrt{kₚ*prediction deviation of second object}+\sqrt{prediction deviation of first object−kₚ}
wherein, kₚ denotes a dimensionally normalized value for a prediction deviation between the size of the adaptive convolutional kernel in the current module and the first object as well as the second object.

20. The computer-readable storage medium according to claim 19, wherein a small-object prediction deviation is expressed by a Hausdorff distance, specifically as follows:
Hausdorff(A,B)=max{h(A,B),h(B,A)}
h(A,B)=max_{a∈A} min_{b∈B}∥a−b∥
h(B,A)=max_{b∈A} min_{a∈B}∥b−a∥
a large-object prediction deviation is expressed by a Dice coefficient, specifically as follows:
$$Dice = \frac{2 \times \vert A ⋂ B \vert}{\vert A \vert + \vert B \vert}$$
wherein, A={a¹, a², . . . , a^{p}}, and B={b¹, b², . . . , b^{p}}; A is a predicted pixel set; B is a ground truth label pixel set; and ∥a−b∥ denotes a Euclidean distance between two pixels.
